(19) United States
(12) Patent Application Publication
(10) Pub. No.: US 2007/0031594 A1
(43) Pub. Date: Feb. 8, 2007

(54) Method for making a metal decorative effect on the surface of an object

(76) Inventor: Luigi Turrini, Modena (IT)

Correspondence Address: YOUNG & THOMPSON, 745 SOUTH 23RD STREET, 2ND FLOOR, ARLINGTON, VA, 22202, US

(21) Appl. No.: 10/571,888

(22) PCT Filed: Sep. 17, 2004
(86) PCT No.: PCT/IB04/03035

§ 371 Date: Mar. 14, 2006

(30) Foreign Application Priority Data
Sep. 17, 2003 (IT) PI2003A000070

(51) Int. Cl. B05D 1/02; B05D 1/08; C23C 4/00

(52) U.S. Cl. 427/180; 427/446; 427/421.1

(57) ABSTRACT

Method for metallizing the surface of an object. The process begins with the location of the plate in the vicinity of elements for delivering molten metal, towards which a metal supply is fed in the form of metal wires for example through guided by sheaths. In the means for melting and in particular at melting site the melting occurs of the metal source. This can be carried out by discharging an electrical arch between two electrodes, or between an electrode and a metal wire that in this case works as second electrode, or still discharging an electrical arch directly between the metal wires. Alternatively, the melting of the metal wire, can be executed using a combination of a 20 current of gas fuel and a current of a comburent gas burning at high temperature at the melting site.

### FIELD OF THE INVENTION

The present invention relates to a method for making a metal decorative effect on the surface of an object, for example a support of ceramics or other inert material, of stone, wood, plastics, glass, metal and resinous material 10 with or without embedded inert material, in order to provide a decorative element for the building and furnishing industry.

Furthermore, the invention relates to a decorative element executed with this method for coating and flooring surfaces.

### BACKGROUND OF THE INVENTION

Many methods are known in the building industry to make decorative elements for coating and flooring internal and external surfaces, having a visible metal face for offering a particular aesthetic effect.

With the present techniques the coating of a wall, a ceiling, or a floor with tiles completely made of metal has relevant drawbacks, among which the weight, the high costs and problems of corrosion. It is, therefore, preferable to apply a metal layer to a substrate of different type, for example of ceramics or other inert material, of stone, wood, plastics, resinous material, etc.

A process used to achieve this object provides the surface metallization of the substrate by a galvanic process that consists of firstly making the tile surface conductive dipping it in a basin of highly conductive molten metal, for example copper, and then putting in a basin with a solution where a process of electrolysis is carried out. More in detail, in the second basin electrodes are arranged that crossed by a determined current melt and carry out the deposition for electrolysis of the metal material of which the electrodes are made on the tiles, obtaining the desired metal coating.

However, the apparatus used to provide the process above described are bulky, not much flexible and require very long operative time. This affects unavoidably the costs of the final product and therefore is not competitive with respect to other solutions present on the market.

Other existing methods provide the application of molten metal directly on the substrate to coat by partial dipping in metal bath, or applied by a roller like certain printing apparatus. Such processes, however, do not provide a homogeneous distribution of the metal material on the surface of the substrate, since it is not possible to control with precision the parameters of process.

A further drawback common to all the metallization processes presently used is the presence of humidity in the porosity of the tiles. In fact the humidity causes eventually the metal to detach from the substrate and causes it to wear by oxidization or for reasons of other nature.

It is also felt the problem of adjusting the brightness/opacity and chromatic effects of metal objects or objects already coated of metal.

### SUMMARY OF THE INVENTION

It is therefore a feature of the present invention to provide a method for making a decorative effect on the surface of an object, for example a ceramic support or other inert material, of stone, wood, plastics, of glass, of resinous material, metal, or combination of them, which allows quickly and precisely the distribution of the molten metal on the support same.

It is another feature of the present invention to provide a method for making a decorative effect on the surface of an object that allows to obtain a decorative element for the building or furnishing industry, or an artistic object of high aesthetic quality and with a good mechanical resistance as well as resistance to exposure to the environment.

It is another feature of the present invention to provide a method for making a decorative effect on the surface of an object for adjusting the brightness/opacity and creating particular chromatic effects on the surface of metal objects or of objects already coated of metal without the use of toxic or dangerous substances as strong acids used, for example, in systems of catalysis.

These and other objects are achieved with the method for making a decorative effect on the surface of an object comprising the steps of:
arranging an object in the vicinity of means for delivering molten metal,
feeding a metal supply to the means for delivering,
melting the metal supply through the melting means at the means for delivering thus creating small particles of molten metal,
contemporaneous feeding a gas current at a determined pressure in the means for delivering, the current entraining the particles of molten metal bringing them on the surface of the object to coat.

Advantageously, the melting step of the metal supply through the melting means is carried out at a pressure equal or less than atmospheric.

In particular, the means for delivering have a melting site directly upstream from a nozzle, whereby the current of gas in pressure, in particular air, conveys the particles of molten metal and brings them through the nozzle spreading them on the surface to coat.

Advantageously, the gas current at a determined pressure is created by a main gas flow at a fixed pressure and an auxiliary gas flow at an adjustable pressure. This way, it is possible to adjust the pressure of the gas flow, for example air, fed to the melting site by adjusting the pressure of the auxiliary gas flow. This allows to control the parameters of process, in particular changing the cooling speed of the particles, the exiting speed from the nozzle, the micronization of the particles. This way, can be provided different aesthetic effects on the surface of the object simply by adjusting the pressure of the gas supplied towards the melting site, thus obtaining highly flexible a process.

Advantageously, the metal supply is at least one metal wire.

Advantageously, the melting means are actuated by an electrical arch that discharges between the material supply and an electrode consisting of a inert conductive material or a meltable material selected from the group:
at least one metal wire,
at least one metal powder associated to an inert electrode,
at least one metal oxide.

Alternatively, the melting means are actuated by the combustion of a gas fuel, for example acetylene, with a comburent gas, for example oxygen, at the melting site.

Preferably, at least a first wire metal supply in soft metal and at least a second wire metal supply in metal or metal alloy different from that of the first layer.

In this case, the metallization of the object provides the preliminary application of a soft metal layer on the surface to coat and a successive application of a decorative metal layer on the soft metal layer. The preliminary application of the soft metal layer on the support creates a “adhesive” surface for the decorative metal layer that allows the latter to fix steadily to the surface of the object to coat.

Preferably, the soft metal used to provide the adhesive layer is selected from the group of tin, aluminium, zinc.

Preferably, the metal used to provide the decorative layer is selected from the group of copper, brass, steel, bronze, and various alloys with decorative function.

Advantageously, preliminarily to the step of application of a metal layer on the surface of the object to coat, according as described above, a drying step is provided, for example in an oven, for removing the humidity that can be present in the porosity of the material of which the object is made.

Advantageously, the possible drying step is followed by a step of application of a layer of waterproofing material on the surface opposite to the surface to metallize. this avoids that the humidity can permeate the porosity of the material of the support affecting the metallization step.

At the end of the metallization step the metal coated surface of the object can be subject to at least one step of finishing, for example, an oxidization of at least one portion of the external metal layer.

Other finishing operations can be, for example, polishing the metal coated surface and/or treating it with specific products suitable for providing a protective layer on the metal surface.

According to the invention a method for making a decorative effect on the surface of an object, said object comprising at least one metal layer, provides a step of oxidization of at least one portion of the metal layer wherein the oxidization of the metal layer is carried out electrochemically and comprises the steps of:
arranging the object having at least one metal layer in the vicinity of oxidizing means;
feeding a measured amount of a saline solution towards said oxidizing means;
applying a voltage to said oxidizing means, said oxidizing means discharging an electric current on said metal layer and causing the oxidization of at least one portion thereof.

Advantageously, the or each metal layer is obtained with a metallization step as above described.

In particular, the saline solution comprises at least one metal ion type.

Advantageously, the oxidizing means comprise at least a first conductive element and at least a second conductive element connected respectively to the positive pole and to the negative pole of a electric current generator. The first and the second conductive element may contact the metal layer by a pad of spongy material that spreads the solution on the metal layer. According to the type of metal chosen to provide the metal layer and metal ion type dissolved in the saline solution it is possible to provide a particular aesthetical effect on the surface to decorate. The process for electrochemical oxidization above described avoids the use of toxic or dangerous substances as strong acids used, for example, in systems of catalysis, and provides an oxidization of the metal layer that stops at a predetermined stage without proceeding further with time.

Preferably, the electric current supplied to the oxidizing means is applied with a voltage less than 20 volts.

The decorative element obtained at the end of the process above described can be used in different fields, among which building and furnishing industry, advertisement, artistic products, etc.

According to another aspect of the invention a decorative element for the building and furnishing industry comprises an object, in particular of ceramics or other inert material, of stone, wood, plastics, glass, resinous material with or without inert embedded, of metal, having at least one metal coated surface as described above.

### BRIEF DESCRIPTION OF THE DRAWINGS

The invention will now shown with the following description of an exemplary embodiment thereof, exemplifying but not limitative, with reference to the attached drawings wherein:
FIG. 1 shows diagrammatically a perspective view of the means for delivering that carry out the method for metallizing the surface of an object, according to the present invention,
FIGS. from 2A to the 3B show diagrammatically in cross section some possible exemplary embodiments of a head of application as of FIG. 1,
FIG. 4 shows a perspective view of a first exemplary embodiment of a decorative element for the building and furnishing industry obtained with the method according to the invention,
FIG. 5 shows the decorative element of FIG. 4 in a cross sectional view according to arrows V-V,
FIG. 6 shows a first exemplary embodiment of the decorative element of FIG. 4,
FIG. 7 shows an exemplary embodiment of the decorative element of FIG. 6 in a cross sectional view according to arrows VI-VI,
FIG. 8 shows a further exemplary embodiment of the decorative element of FIG. 4,
FIG. 9 shows an exemplary embodiment of FIG. 8 in a cross sectional view according to arrows IX-IX;
FIG. 10 shows diagrammatically in a partially cross sectioned view an exemplary embodiment of a device to provide the oxidization of the metal layer of the element of FIG. 4;
FIG. 11 shows diagrammatically in an elevational side view the device to provide the oxidization of the metal layer of FIG. 10.

### DESCRIPTION OF A PREFERRED EXEMPLARY EMBODIMENT

In FIG. 1 the means for delivering 1 are shown used for carrying out the method for metallizing the surface of an object, for example a support 20 of ceramics or other inert material, of stone, wood, plastics, of glass, of resinous material with or without inert embedded therein, of metal, according to the present invention.

In particular, the process begins arranging the support 20 in the vicinity of the means for delivering molten metal 1 towards which a metal supply is fed in the form of metal wires 2 and 3 for example through sheaths 4 (FIG. 1).

In the melting means 1 and in particular at a melting site 15 (FIGS. 2A, 2B, 3A and 3B) the melting step of the metal supply 2, or 3 is effected. This can be carried out for discharging an electrical arch between two electrodes 16 and 17 (FIG. 2A), or, between an electrode 16 and a metal wire 2 that in this case works as second electrode (FIG. 2B), or still by discharging the electrical arch directly between metal wires 2 and 3 (FIG. 3A), or alternatively, by means of electrical arch, metal dust and metal oxides.

In all the cases above described the electrical arch is discharged produced by an electric current generator, not shown in the figures, which delivers a certain current at the ends of the elements, either electrodes 16, or 17 and/or metal wires 2, or 3, dust or metal oxides or powder.

In case a single metal wire 2, or 3 is used, the voltage (ΔV) applied between the two electrodes 16 and 17 (FIG. 2A) or between an electrode 16 and a metal wire 2 (FIG. 2B) or between an electrode and dust or metal oxides, produces the electrical arch that causes the melting step of the metal wire or metal powder 2, or 3, melting it in the melting site 15, thus creating small particles of molten metal 102, or 103.

If the electrical arch is discharged directly between the two metal wires 2 and 3, they melt at the same time and mix with each other obtaining particular aesthetic effects (FIG. 3A). For example, if the electrical wires 2 and 3 have different colour their mixing provides a metal layer 25 with special nuances. wires can be used also of material different metal thus obtaining a metal alloy directly on the surface 21 to coat.

At the same time of the melting step of one or both the metal wires 2 and/or 3 a gas current is supplied at a determined pressure 40, for example air, at the melting site 15 that entrains particles of molten metal 102, or 103, or 102 and 103, bringing them on the surface 21 of the support 20.

Alternatively, the melting step of the metal wire 2 can be executed using a combination of a current of fuel 40a, for example i.e. acetylene, and of a current of comburent 40b, such as pure oxygen or air, that burn at high temperature 21 in the melting site 15 (FIG. 3B).

The air flow 40 of FIGS. 2A, 2B and 3A is effected at a determined pressure by a main air flow 41 at a fixed pressure fed to the means for delivering 1 through the duct 7 and an auxiliary air flow 42 at an adjustable pressure that reaches the means for delivering 1 through duct 8 (FIG. 1). This way, it is possible to adjust the pressure of the air flow 40 fed to the melting site 15 by adjusting the pressure of the auxiliary air flow 42. Similarly, if the melting step of the metal wire is carried out by burning at high temperature 21 of FIG. 3B, it is possible to provide an auxiliary current, for example of air or of inert gas for adjusting easily the operative conditions in the melting site 15.

According to the invention, using the above described method allows to provide different decorative elements 30. In particular, it is possible to obtain decorative elements 30 simply metallizing a surface 21 as described above (FIGS. 4 and 5).

Alternatively, it is possible to provide decorative elements 30 of special aesthetic quality and with good mechanical and environmental resistance, as in the case shown in FIGS. from 6 to the 9.

More in detail, to provide the decorative element of FIGS. 8 and 9 a first wire metal supply 2 is used of soft metal, for example tin, aluminium zinc, and a second wire metal supply 3 in pure metal or alloys, such as bronze, steel, copper, brass, etc. The metallization of the support 20 comprises, in fact, the preliminary application of a soft metal layer 26 “adhesive” on the surface 21 to coat, and then the application of a decorative metal layer 25 on the Soft Metal Layer 26. This allows a steady fixing of the decorative layer 25 to the support 20. The decorative element 30 executed with the method according to the invention can provide, at the surface 22 not suitable for being coated by metal, a layer of waterproofing material 27 (FIGS. from 6 to 9). This avoids that the humidity previously eliminated through a drying step in an oven can again permeate the porosity of the support 20 affecting the following metallization step.

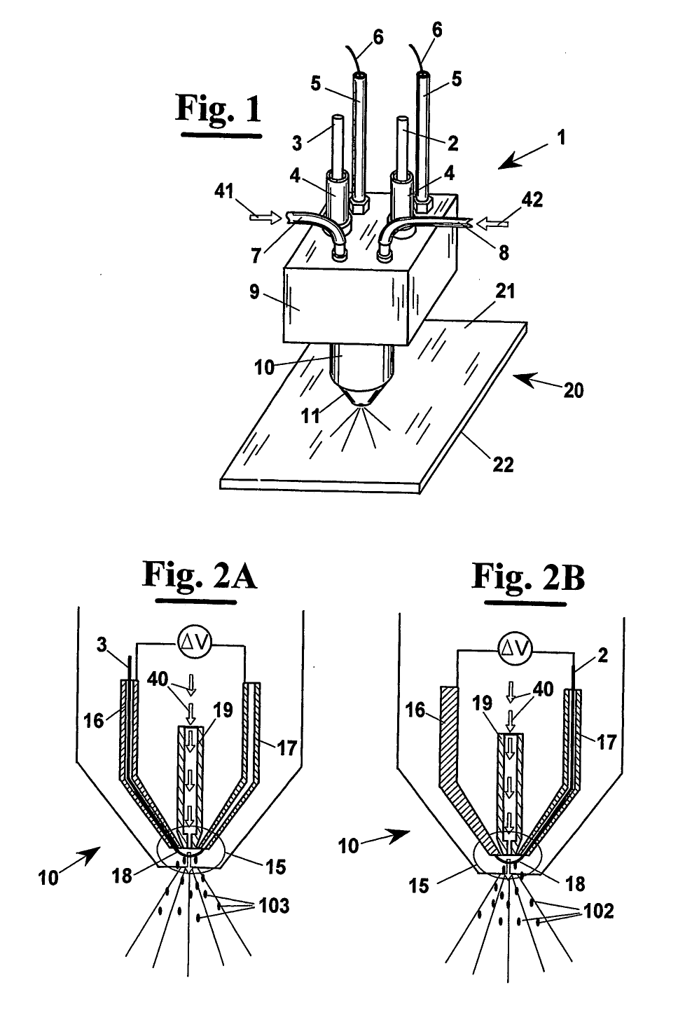

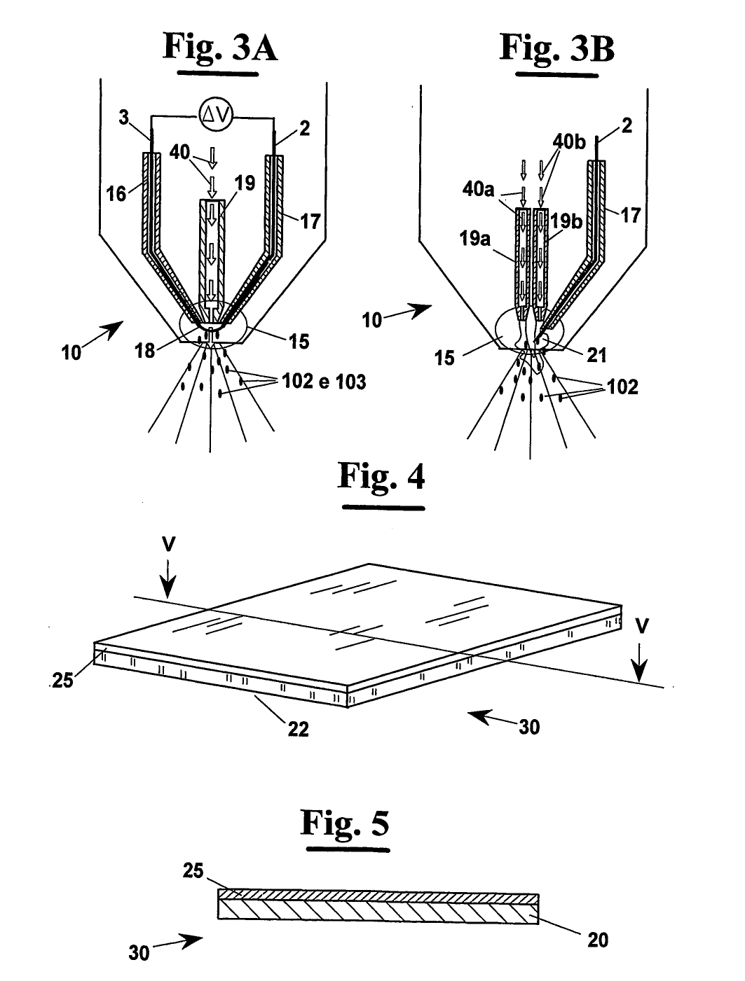

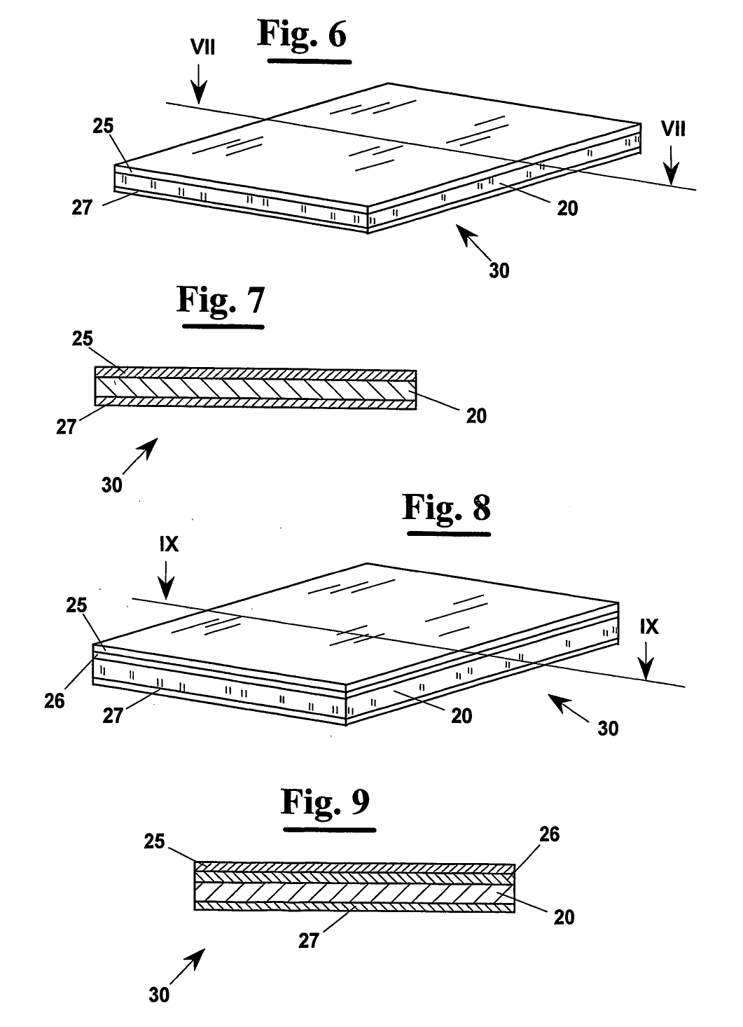

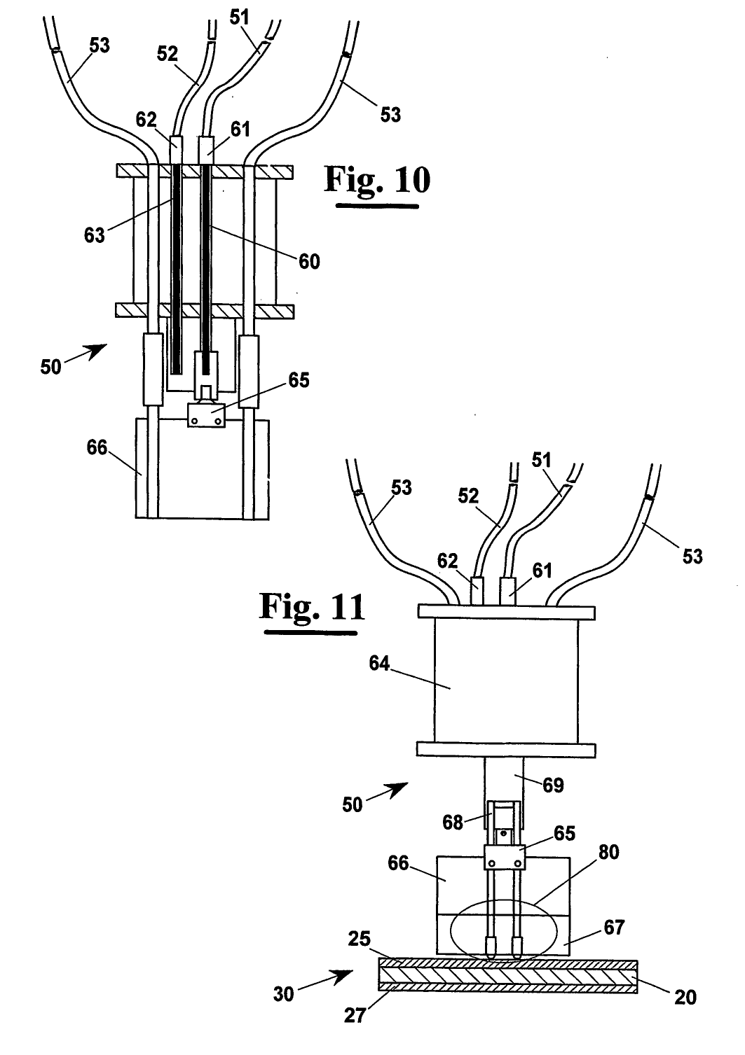

At the end of the process for metallization of the object for the production of a surface metal layer possible finishing operations are provided. In particular, in FIGS. 10 and 11 a possible exemplary embodiment is shown of an apparatus to provide the at least partial oxidization of the metal layer.

The oxidization can be made on a surface of an object previously coated with metal according to the process above described, or on a surface of a metal piece, for creating on the metal surface particular aesthetic effects and then to stop the oxidization at a predetermined stage without that the oxidization continues manifestly with time.

More in detail, the apparatus for oxidization of the metal layer shown in FIGS. 10 and 11 is supplied by an electric current generator (not shown in the figure). The current supplied can be both direct and alternated, can be adjustable, and variable voltage, for example of 12 volts. This is made through a first and a second electrical cable 51 and 52 respectively connected to the positive pole and to the negative pole of the current generator.

In particular, the electrical cable 51 is connected to one of the electrodes of the current generator and brings the current to a discharging zone 80, defined in FIG. 11 by a dotted line, through a plurality of elements conductive 60, 65 and 66, for example made of graphite. Similarly, cable 52 is connected to another electrode of the generator of current and, by a plurality of conductive elements 63 and 58, electrically insulated from the remainder of the apparatus 50, it conduces the relative electrical charges to a discharge site 80. Here a measured amount of a saline solution is supplied, containing at least one metal ion type, through one or more ducts 53. In particular, as diagrammatically shown in FIG. 11, the saline solution can be gathered at a pad 67 or other spongy material. Approaching the lower end of the conductive element 68 of apparatus 50 to object 30, and in particular to metal layer 25, a grounded contact is made. The dissociated metal ions present in the saline solution on pad 67 cause then the electric current to discharge at 80 on the metal surface 25 and then causing the electrochemical oxidization of the same.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Method for making a decorative effect on the surface of an object characterised in that it comprises the steps of:
arranging an object in the vicinity of means for delivering molten metal,
feeding a metal supply to said means for delivering,
melting said metal supply at said means for delivering thus creating small particles of molten metal,
contemporaneous feeding a gas current at a determined pressure in the means for delivering, the current entraining the particles of molten metal bringing them on the surface of the object to coat.

2. Method, according to claim 1, wherein said melting of said metal supply by said melting means is carried out in an environment at a pressure lower than or the same as atmospheric.

3. Method, according to claim 1, wherein said means for delivering have a melting site directly upstream from a nozzle whereby the gas current at a determined pressure conveys the said particles of molten metal and brings them through said nozzle spreading them on said surface to coat.

4. Method, according to claim 1, wherein said gas current at a determined pressure is created by a main gas flow at a fixed pressure and an auxiliary gas flow at an adjustable pressure, whereby it is possible to adjust the pressure of said gas flow fed to the melting site by adjusting the pressure of said auxiliary gas flow.

5. Method, according to claim 1, wherein said metal supply is at least one metal wire.

6. Method according to claim 6, wherein said melting means are actuated by an electrical arch that discharges itself between said material supply and an electrode consisting of a inert conductive material or a meltable material selected from the group:
at least one metal wire,
at least one metal powder associated to an inert electrode,
at least one metal oxide.

7. Method according to claim 1, wherein said melting means are actuated by the combustion of a gas fuel with a comburent gas at said melting site.

8. Method, according to claim 5, where at least a first wire metal supply in soft metal and at least a second metal wire in metal or metal alloy different from that of the first layer are provided.

9. Method, according to claim 8, where the metallization of said object provides the preliminary application of a soft metal layer on the surface to coat and the successive application of a decorative metal layer on the soft metal layer.

10. Method, according to claim 9, wherein said soft metal is selected from the group of tin, aluminium, zinc and said hard metal, is selected from the group of copper, brass, steel, bronze, and various alloys with decorative function.

11. Method, according to claim 1, wherein preliminarily to said step of application of a metal layer on said surface of said object to coat a drying step is provided, for example in an oven, for removing the humidity that can be present in the porosity of the material of which is said object is made.

12. Method, according to claim 11, wherein said drying step is followed by a step of application of a layer of waterproofing material on the surface opposite to said surface to metallize.

13. Method, according to claim 1, wherein at the end of the metallization step said metal coated surface of said object is subject to at least one step of finishing, wherein said step of finishing is an oxidization of at least one portion of the external metal layer.

14. Method, to provide a decorative effect on the surface of an object, said object comprising at least one metal layer, characterised in that it provides a step of oxidization of at least one portion of said metal layer, wherein said step of oxidization of said metal layer is carried out electrochemically and comprises the steps of:
arranging the object having at least one metal layer in the vicinity of oxidizing means;
feeding a measured amount of a saline solution towards said oxidizing means;
applying a voltage to said oxidizing means, said oxidizing means discharging an electric current on said metal layer and causing the oxidization of at least one portion thereof.

15. Method according to claim 14 wherein said at least one metal layer is obtained with a metallization step.

16. Method, according to claim 14, wherein said saline solution comprises at least one metal ion type.

17. Method, according to claim 14, wherein said oxidizing means comprise at least a first conductive element and at least a second conductive element connected respectively to the positive pole and to the negative pole of an electric current generator, contacting said metal layer by a pad of spongy material that spreads said solution on said metal layer.

18. Method, according to claim 14, wherein said electric current supplied to the oxidizing means is applied with a voltage less than 20 volts.

19. Decorative element for the building industry and furnishing characterised in that it comprises an object, in particular of ceramics or other inert material, of stone, wood, plastics, in metal, having at least one metal coated surface according to claim 1.
